(19) United States
(12) Patent Application Publication
(10) Pub. No.: US 2024/0351777 A1
(43) Pub. Date: Oct. 24, 2024

(54) CAPSULE FOR PREPARING A BEVERAGE

(71) Applicant: Glatfelter Gernsbach GmbH, Gernsbach (DE)

(72) Inventors: Jörg Kühn, Ötigheim (DE); Bernd Seger, Bad Herrenalb (DE); Thomas Tischer, Karlsruhe (DE); Eduardo Castilla, Baden Baden (DE); Nicole Schmid, Gernsbach (DE); Dijana Ladanji, Gernsbach (DE); Sebastian Borner, Bad Herrenalb (DE)

(73) Assignee: Glatfelter Gernsbach GmbH, Gernsbach (DE)

(21) Appl. No.: 18/579,321

(22) PCT Filed: Jul. 15, 2022
(86) PCT No.: PCT/EP2022/069862

§ 371 Date: Jan. 12, 2024

(30) Foreign Application Priority Data
Jul. 16, 2021 (EP) 21186187.7

(51) Int. Cl. B65D 85/804; B65D 65/46

(52) U.S. Cl. CPC B65D 85/8043; B65D 65/466

(57) ABSTRACT

The present invention relates to a capsule (10) for preparing a beverage, in particular coffee or tea, the capsule comprising one or more fiber layers comprising fibers, and one or more polymer layers comprising a polymer selected from the group consisting of polylactic acid (PLA), polybutylene succinate (PBS), polybutylene adipate terephthalate (PBAT), polyhydroxyalkanoate (PHA), a polysaccharide or combinations thereof.

### FIELD OF THE INVENTION

The present invention relates to a capsule for preparing a beverage, such as coffee or tea, in particular to a single-use or single-serve capsule having advantageous characteristics in terms of sustainability (such as natural basis and/or in particular biodegradability) and/or barrier properties (in particular oxygen, aroma, water vapor and/or liquid barrier).

### BACKGROUND

Conventional single-use capsules used for preparing hot beverages, in particular coffee, are typically made from aluminium or plastic material, thus posing severe ecological problems. During the last years, the environmental aspect of the end-of-life of single use consumer goods became more and more important for the general public, as well as for brand owners and legislative bodies. Therefore, it became more and more important for brand owners to offer more sustainable product ranges, allowing customers to minimize their environmental footprint.

Previous attempts in this regard include the following: US 2011/0259205 A1 proposes a capsule system comprising a paper-based wall with wax coating to form a biodegradable alternative for single use beverage pods. U.S. Pat. No. 8,656,827 B2 proposes a capsule system which is not harmful for the environment and employs compostable materials, such as polylactic acid (PLA). WO 2008/148650 A1 outlines a coffee capsule system based on polypropylene (PP) and an EVOH gas barrier layer. US 2018/0362198 A1 proposes a capsule system employing a bicomponent PLA fiber to be used in a nonwoven filter for coffee and tea applications. EP 3221238 B1 proposes a capsule system based on a cellulose based capsule body and a sealing film made of edible material containing alginic acid/alginate. WO 2017/144009 A1 proposes to make a consumer product, such as a coffee capsule, by a material comprising a pulp and a fibrillated cellulose, wherein the pulp and the fibrillated cellulose are independently derived from a plant fiber, and optionally an additional polymer. WO 2020/224952 A1 proposes a capsule, in particular for preparing a beverage from beverage powder, comprising a capsule body composed of at least one polysaccharide and filled with a material containing polysaccharide, the capsule body being entirely encased by at least one coating layer comprising at least one polyvinyl alcohol and/or a polyvinyl alcohol copolymer. FR 3 035 085 A1 proposes a capsule comprising a hollow body capable of receiving an ingredient, wherein the body comprises a side wall that is closed by a bottom at a first end, and bordered by a flange at a second end, and a cover attached to the flange to close said second end of the side wall, characterized in that the cover is composed of at least one paper membrane covered with at least 5 g/m² of a layer of resin which comprises one or more initiators of rupture, so that the resin layer is positioned between said paper membrane and the body. US 2021/0171739 A1 proposes to make an article, for instance a beverage pod, from a polymer composition comprising a cellulose acetate, at least one bio-based polymer comprising a polylactic acid, a polycaprolactone, or a polyhydroxyalkanoate, and a plasticizer. WO 2017/063680 A1 discloses a capsule for preparing beverages comprising a housing having a peripheral wall and a bottom wall, and a closing element composed of a laminated foil comprising a weakened layer, a carrier layer at least partially composed of paper, and an oxygen barrier layer.

However, previous attempts have so far not been fully satisfying concerning a substantially complete biodegradability and at the same time exhibiting appropriate mechanical properties and barrier properties.

Thus, there is still room for further improvements in providing a biodegradable capsule suitable for preparing a hot beverage.

### OBJECT OF THE INVENTION

The present invention aims at overcoming the above described problems and drawbacks. Thus, it is an object of the present invention to provide a capsule suitable for preparing a (hot) beverage, such as coffee or tea, that can substantially entirely biodegrade after use and at the same time exhibits appropriate mechanical properties (such as a sufficient mechanical strength) and barrier properties (in particular oxygen, aroma, water vapor and/or liquid barrier).

### SUMMARY OF THE INVENTION

The present inventors have made diligent studies and have found that this object can be solved by using a capsule material comprising one or more fiber layers and one or more polymer layers (or coatings) comprising specific polymers being in particular bio-based, biodegradable and/or heat-sealable. Without wishing to be bound to any theory, the present inventors assume that the combination of one or more fiber layers with one or more layers of specific polymer provide for sufficient mechanical strength and barrier properties, even though the materials are substantially biodegradable.

Accordingly, the present invention relates to a (single-use, single-serve) capsule for preparing a beverage, in particular coffee or tea, the capsule comprising one or more fiber layers comprising fibers, and one or more polymer layers (coatings) comprising a polymer selected from the group consisting of polylactic acid (PLA), polybutylene succinate (PBS), polybutylene adipate terephthalate (PBAT), polyhydroxyalkanoate (PHA), a polysaccharide or combinations thereof.

Other objects and many of the attendant advantages of embodiments of the present invention will be readily appreciated and become better understood by reference to the following detailed description of embodiments and the accompanying drawings.

### BRIEF DESCRIPTION OF THE DRAWINGS

FIG. 1 schematically illustrates a capsule according to an embodiment in a cross-sectional view.

### DETAILED DESCRIPTION OF THE INVENTION

Hereinafter, details of the present invention and other features and advantages thereof will be described. However, the present invention is not limited to the following specific descriptions, but they are rather for illustrative purposes only.

It should be noted that features described in connection with one exemplary embodiment or exemplary aspect may be combined with any other exemplary embodiment or exemplary aspect, in particular features described with any exemplary embodiment of a capsule may be combined with any other exemplary embodiment of a capsule, with any exemplary embodiment of a process for producing a capsule and vice versa, unless specifically stated otherwise.

Where an indefinite or definite article is used when referring to a singular term, such as “a”, “an” or “the”, a plural of that term is also included and vice versa, unless specifically stated otherwise, whereas the word “one” or the number “1”, as used herein, typically means “just one” or “exactly one”.

The expression “comprising”, as used herein, includes not only the meaning of “comprising”, “including” or “containing”, but may also encompass “consisting essentially of” and “consisting of”.

In a first aspect, the present invention relates to a capsule suitable for preparing a (hot) beverage, in particular coffee or tea. To this end, the capsule may be filled with a soluble or brewable food, such as coffee or tea powder. The capsule may in particular be a single-use capsule or a single-serve capsule, i.e. supposed to be used only once and disposed after use. For such disposable article, biodegradability is of utmost importance to avoid large amounts of waste that is hardly recyclable, all the more when filled with (leached) coffee or tea powder residues. In contrast, a capsule according to an embodiment of the present invention may be (substantially completely) biodegradable and may therefore be disposed even when filled with (leached) coffee or tea powder residues entirely as organic waste or even at a home compost.

The term “capsule”, as used herein, may in particular mean a container or closed pod that is adapted to accommodate soluble or brewable food, such as coffee or tea powder, and allows for preparing a beverage, such as a hot beverage. To this end, a capsule typically comprises a bottom (or bottom disk), a side wall and a lid (or cover), and the capsule may for instance be inserted in a capsule coffee brewing machine, where brewing is achieved by insertion of a hot water injection needle tube pricking a hole in the lid material and, concurrently, insertion of a coffee liquid outlet tube creating a hole in the bottom disk material.

The capsule, more specifically the material constituting the capsule, comprises one or more fiber layers and one or more polymer layers. In particular, the capsule may comprise one, two, three or more fiber layers and one, two, three or more polymer layers.

In an embodiment, at least one polymer layer is arranged on the one or more fiber layers such that it (i.e. the polymer layer) faces towards an interior of the capsule. In addition or alternatively, at least one polymer layer may be arranged on the one or more fiber layers such that it (i.e. the polymer layer) faces towards an exterior of the capsule. Thus, a polymer layer or polymer coating may be provided on any surface side as well as on both surface sides of the capsule.

In an embodiment, the capsule comprises two or more fiber layers. In this embodiment, it may be advantageous if at least one polymer layer is arranged (sandwiched) between two adjacent fiber layers, i.e. a polymer layer forming an intermediate layer between two fiber layers. By taking this measure, the mechanical strength of the capsule may be increased. In addition, a specific functionality, in particular a specific barrier property, may be provided by a certain polymer layer without direct contact of this particular polymer layer with the interior of the capsule (such as a soluble or brewable food or a beverage prepared therefrom) or the exterior of the capsule (such as the environment). Nevertheless, also in this embodiment, a(nother) polymer layer(s) or polymer coating(s) may be provided on any surface side as well as on both surface sides of the capsule.

In an embodiment, the one or more fiber layers comprises one or more (wet-laid) layers comprising wood pulp, such as softwood and/or hardwood pulp. Wood pulp may in particular denote a (lignocellulosic) fibrous material prepared by chemically or mechanically separating cellulose fibers from wood, such as by a kraft process (sulfate process). Kraft wood pulp may include northern bleached softwood kraft (NBSK) and southern bleached softwood kraft (SBSK) as well as their unbleached variants. The wood pulp may also be refined, such as beaten.

In this embodiment, the one or more fiber layers are preferably wet-laid layers, such as a wet-laid non-woven web (which may also be referred to as “fabric” or “paper”). In other words, the one or more layers comprising wood pulp are preferably made by a wet-laid process, for instance by a conventional paper-making process using a wet-laid machine, in particular by means of an inclined wire papermaking machine, as described for instance in U.S. Pat. No. 3,785,922, the disclosure of which is incorporated herein by reference, or a fourdrinier paper machine.

In an embodiment, the one or more fiber layers comprises one or more (air-laid) layers comprising fluff pulp (also simply referred to as “fluff”). The raw material of fluff pulp may also be softwood, such as SBSK or NBSK, which may be defibrized in a hammermill so as to obtain a fluffy or bulky material.

In this embodiment, the one or more fiber layers are preferably air-laid layers, such as a cellulosic air-laid substrate. In other words, the one or more layers comprising fluff pulp are preferably made by an air-laid process, for instance by a dry-forming air-laid non-woven manufacturing process, described for instance in U.S. Pat. No. 3,905,864, the disclosure of which is incorporated herein by reference.

In an embodiment, at least a part of the fibers is entangled with each other, such as by hydroentanglement or needle punching. Hydroentanglement (which may also be referred to as spunlacing) is a bonding process for wet or dry fibrous webs where fine, high pressure jets of water penetrate the fibrous web and cause an entanglement of fibers. Needle punching is a bonding process where fibers are mechanically intertwined by needles. By taking this measure, not only the mechanical stability or strength of the fiber layers(s) and the entire capsule material may be increased, but also its stretchability or tensile strength may be improved (which may in particular be relevant when the capsule is formed by deep-drawing or punch drawing).

In an embodiment, the pulp fibers, such as wood pulp and/or fluff pulp, may have an average fiber length of from 1.0 mm to 4.0 mm, for instance from 1.5 mm to 3.5 mm, such as from 2.0 mm to 3.0 mm. In an embodiment, the pulp fibers, such as wood pulp and/or fluff pulp, may have a fiber coarseness of from 0.3 to 3.5 dtex, such as from 0.6 to 2.5 dtex.

In an embodiment, the one or more fiber layers comprises (based on the total weight of the fibers):
40 to 100 wt.-% of pulp fibers (such as wood pulp and/or fluff pulp), such as from 50 to 95 wt.-% pulp fibers, such as from 60 to 90 wt.-% pulp fibers, in particular from 70 to 80 wt.-% pulp fibers;
0 to 20 wt. % of (long) cellulosic fibers, such as from 5 to 10 wt.-% (long) cellulosic fibers,
0 to 20 wt. % of regenerated (man-made) cellulose fibers, such as from 5 to 10 wt.-% regenerated cellulose fibers, and
0 to 20 wt.-% of thermoplastic biodegradable fibers, such as from 5 to 10 wt.-% thermoplastic biodegradable fibers.

The (long) cellulosic fibers (for instance from annual plants) may have an average fiber length of from 3 mm to 12 mm, such as from 4 mm to 10 mm, and may be selected from the group consisting of hemp fibers, manila fibers, jute fibers, sisal fibers, abaca fibers or combinations thereof. Moreover, cellulose acetate fibers may be suitable as well.

The term “regenerated cellulose fibers”, as used herein, may in particular denote man-made cellulose fibers obtained by a solvent spinning process. In an embodiment, the regenerated cellulose fibers may be selected from the group consisting of viscose (rayon) or lyocell (tencel). Viscose is a type of solvent spun fiber produced according to the viscose process typically involving an intermediate dissolution of cellulose as cellulose xanthate and subsequent spinning to fibers. Lyocell is a type of solvent spun fiber produced according to the aminoxide process typically involving the dissolution of cellulose in N-methylmorpholine N-oxide and subsequent spinning to fibers.

The term “thermoplastic biodegradable fibers”, as used herein, may in particular denote biodegradable fibers that soften and/or partly and/or fully melt when exposed to heat and are capable to bind with each other or to other non-thermoplastic fibers, such as cellulose pulp fibers, upon cooling and resolidifying. For example, the thermoplastic biodegradable fiber may be selected from the group consisting of a polylactic acid (PLA), a polybutylene succinate (PBS), a polybutylene adipate terephthalate (PBAT), a polyhydroxyalkanoate (PHA) and copolymers of PHA, and other fibers made of biodegradable thermoplastic polymers. Combinations of two or more thereof may also be applied. In an embodiment, the thermoplastic biodegradable fiber comprises a multicomponent fiber, in particular a bicomponent fiber, such as bicomponent fibers of the sheath-core type. Bicomponent fibers are composed of two sorts of polymers having different physical and/or chemical characteristics, in particular different melting characteristics. A bicomponent fiber of the sheath-core type typically has a core of a higher melting point component and a sheath of a lower melting point component. The presence of thermoplastic biodegradable fibers may in particular be advantageous for improving the mechanical properties, such as the mechanical strength, of the fiber layer(s).

In an embodiment, substantially all fibers comprised in the fiber layer(s) may be biodegradable fibers. In other words, it may be advantageous that the fiber layer(s) do substantially not comprise any other fibers than biodegradable fibers or that the fiber layer(s) is (are) substantially free of non-biodegradable fibers. With regard to embodiments comprising “substantially no other fibers than biodegradable fibers” or being “substantially free of non-biodegradable fibers”, other fibers than biodegradable fibers, if any, may still be present in relatively minor amounts of up to 10, up to 5, up to 3, up to 2, or up to 1 wt.-% based on the total weight of the fiber layer(s). Non-biodegradable fibers may be present as long as they meet the requirements of the final certification.

The term “biodegradable” which may also be referred to as “compostable”, as used herein, may in particular mean that the material concerned, such as the fibers, the polymer or the entire capsule, complies at least with the requirements for industrial compostability, for instance in accordance with at least one of EN 13432, EN 14995, ASTM D5988-18, ASTM D6400-19 and ASTM D6868-19, and preferably also with the requirements for home compostability, for instance in accordance with draft prEN 17427, and may preferably also be marine biodegradable, for instance in accordance with ASTM D6691-17.

In an embodiment, substantially all fibers comprised in the fiber layer(s) may be biobased fibers. In other words, it may be advantageous that the fiber layer(s) do substantially not comprise any other fibers than biobased fibers or that the fiber layer(s) is (are) substantially free of non-biobased (such as fossil-based) fibers. With regard to embodiments comprising “substantially no other fibers than biobased fibers” or being “substantially free of non-biobased fibers”, other fibers than biobased fibers, if any, may still be present in relatively minor amounts of up to 10, up to 5, up to 3, up to 2, or up to 1 wt.-% based on the total weight of the fiber layer(s).

The term “biobased” (which may also be referred to as “bio-derived”), as used herein, may in particular mean that the material concerned, such as the fibers, the polymer or the entire capsule, can be derived from material of biological or natural origin, in particular from plants or other renewable entities, rather than fossil sources.

In an embodiment, the one or more fiber layers, in particular in case of wet-laid fiber layers comprising wood pulp, may further comprise a sizing agent. By taking this measure, the hydrophobicity of the fiber layer(s) may be increased, which may not only be advantageous in terms of improved water barrier characteristics, but may also reduce an infiltration or ingress of polymer (from the polymer layer), which may in particular occur in case of a polysaccharide polymer, into the fiber layer. While a certain intermingling of fiber layer and polymer layer may be acceptable or even advantageous in terms of mechanical integrity of the capsule (material), an excessive intermingling of fiber layer and polymer layer should be avoided. Suitable examples of the suitable sizing agent include alkyl ketene dimer and natural resins, such as rosin or lignin.

The one or more polymer layers comprises a polymer selected from the group consisting of polylactic acid (PLA), polybutylene succinate (PBS), polybutylene adipate terephthalate (PBAT), polyhydroxyalkanoate (PHA) and a (thermoplastic) polysaccharide (derivative) or combinations thereof. The polymer may in particular exhibit at least one, such at least two or at least three, preferably all, of the following characteristics: biobased, biodegradable, heat-sealable and non-fibrous.

The term “heat-sealable”, as used herein, may in particular mean a thermoplastic behaviour of the polymer in that it may soften and/or partly or even fully melt when exposed to heat and may bind or least partly fuse with each other or to other material upon resolidifying.

The term “non-fibrous”, which may synonymously or interchangeably also be referred to as “particulate”, as used herein, may in particular denote that the polymer is in the form of particles (characterized for instance by an average particle size), rather than in the form of fibers (characterized for instance by a fiber length or diameter). The term “non-fibrous” in particular serves to differentiate the non-fibrous polymer from a polymer fiber, such as a thermoplastic biodegradable fiber.

The at least one polymer is selected from the group consisting of polylactic acid (PLA), polybutylene succinate (PBS), polybutylene adipate terephthalate (PBAT), polyhydroxyalkanoate (PHA), a polysaccharide or combinations of two or more thereof. The term “polysaccharide” may also include a polysaccharide derivative. The polysaccharide may be thermoplastic itself. It may however also be possible to impart thermoplastic properties to the polymer (in particular in case of a polysaccharide) by appropriate additives, such as a plasticizer. Suitable examples of the polysaccharide may include cellulose, hemicelluloses, starch, pectin or seaweed polysaccharides. Suitable examples of the polysaccharide derivative may include esters or ethers of the foregoing polysaccharides, such as carboxymethyl cellulose (CMC).

In an embodiment, the polymer has a (weight-average) molecular weight of at least 2,000 g/mol, in particular at least 5,000 g/mol, in particular at least 10,000 g/mol, and typically not more than 1,000,000 g/mol, such as not more than 500,000 g/mol. The polymer may include one or more types of repeating units, derived from respective monomers. Thus, the term “polymer” may also include a copolymer or a mixture of polymer and copolymer compounds.

In an embodiment, the one or more polymer layers further comprises one or more additives, for instance a plasticizer (softener), a sizing agent, a wetting agent or a moisturizing agent. By taking this measure, the properties of the polymer layer, for instance the thermoplasticity of the polymer, may be adjusted, as desired. Suitable examples of the plasticizer include sebacates.

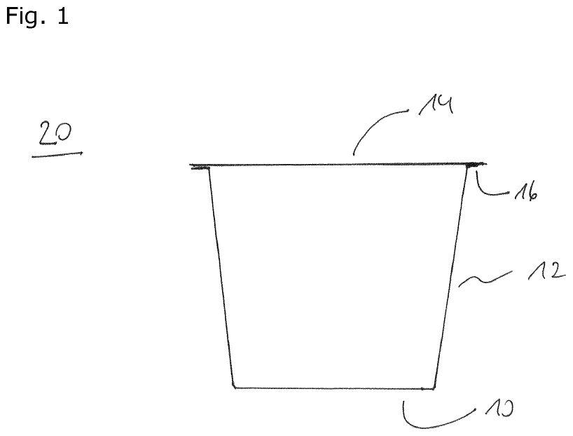

In an embodiment, the capsule comprises a bottom (or bottom disk), a side wall and a lid (or cover). An exemplary embodiment of a capsule in a cross-sectional view is shown in FIG. 1.

As shown in FIG. 1, a bottom 10, such as a bottom disk or circular bottom plate, is connected along its circumference to a side wall 12. Depending on the specific design of the capsule brewing machine, the side wall 12 may be inclined, as shown in FIG. 1, or perpendicular (not shown) with respect to the bottom plane. At the top, the side wall 12 may be outwardly bent, thereby forming a flange or rim 16, on which a cover 14 may be attached, for instance heat-sealed, after a soluble or brewable food, such as tea or coffee powder, has been placed in the (yet open) assembly of bottom 10 and side wall 12.

In an embodiment, the bottom, the side wall and the lid are made of the same material. For instance, the bottom, the side wall and the lid each comprise one or more (wet-laid) fiber layers comprising wood pulp, and one or more polymer layers comprising a polymer selected from the group consisting of polylactic acid (PLA), polybutylene succinate (PBS), polybutylene adipate terephthalate (PBAT), polyhydroxyalkanoate (PHA), a polysaccharide or combinations thereof. Alternatively, the bottom, the side wall and the lid may each comprise one or more (air-laid) fiber layers comprising fluff pulp, and one or more polymer layers comprising a polymer selected from the group consisting of polylactic acid (PLA), polybutylene succinate (PBS), polybutylene adipate terephthalate (PBAT), polyhydroxyalkanoate (PHA), a polysaccharide or combinations thereof.

In an embodiment, the bottom and the side wall are made of the same material and the lid is made of another material (i.e. the material constituting the lid may be different from the material constituting the bottom and the side wall). For instance, the bottom and the side wall each comprise one or more (air-laid) fiber layers comprising fluff pulp, and one or more polymer layers comprising a polymer selected from the group consisting of polylactic acid (PLA), polybutylene succinate (PBS), polybutylene adipate terephthalate (PBAT), polyhydroxyalkanoate (PHA), a polysaccharide or combinations thereof, whereas the lid comprises one or more (wet-laid) fiber layers comprising wood pulp, and one or more polymer layers comprising a polymer selected from the group consisting of polylactic acid (PLA), polybutylene succinate (PBS), polybutylene adipate terephthalate (PBAT), polyhydroxyalkanoate (PHA), a polysaccharide or combinations thereof.

In an embodiment, the grammage or basis weight of the sum of the fiber layer(s) and the polymer layer(s) is in the range of from 100 to 300 g/m², in particular from 150 to 250 g/m², such as from 180 to 230 g/m². The grammage may be determined in accordance with TAPPI T 410 (om-19). The grammage or basis weight of the fiber layer(s) (in total in case of more than one fiber layer) may lie in the range of from 80 to 250 g/m², in particular from 100 to 230 g/m², such as from 120 to 200 g/m². The grammage or basis weight of the polymer layer(s) (in total in case of more than one polymer layer) may lie in the range of from 20 to 50 g/m², such as from 30 to 40 g/m². The ratio of the basis weight of the fiber layers to the basis weight of the polymer layers may range from 5:1 to 20:1, such as from 8:1 to 15:1.

In an embodiment, the capsule (such as the entire capsule material) is biodegradable. In an embodiment, the capsule complies with the requirements of EN 13432 and preferably with home compostability conditions.

In an embodiment, the capsule (such as the capsule material) has a gas transmission rate (gas permeability), in particular an oxygen transmission rate (oxygen permeability), at 23° C. and a relative humidity of 50% of from 1 to 500 cm³/(m² d bar), such as from 2 to 400 cm³/(m² d bar), as determined in accordance with DIN 53380-3:1998-07.

In an embodiment, the capsule (such as the capsule material) has a water vapor transmission rate (water vapor permeability) at 23° C. and a relative humidity of 50% of from 15 to 100 g/(m² d), such as from 20 to 80 g/(m² d), as determined in accordance with ISO 7783:2018.

In an embodiment, the capsule (such as the capsule material) has a water vapor transmission rate (water vapor permeability) at 23° C. and a relative humidity of 85% of from 20 to 250 g/(m² d), such as from 25 to 200 g/(m² d), as determined in accordance with ISO 7783:2018.

Having the above gas and/water transmission rates, the capsule itself may be sufficiently water- and/or gas-tight to allow that an additional (secondary or outer) packaging of the capsule becomes dispensable, which is highly advantageous from an ecological point of view.

In an embodiment, the capsule (such as the capsule material) has a lipophobicity/oil and grease resistance of up to 12 (i.e. the highest value) according to TAPPI Test Method T 559 cm-12 (3M-KIT test).

In an embodiment, the capsule is particularly well suited for hot beverage preparation, in particular under a certain elevated pressure that may build up upon brewing. The capsule may be filled with soluble or brewable food, such as tea or coffee powder, and may be designed to be inserted in a capsule coffee brewing machine, where brewing is achieved by insertion of a hot water injection needle tube pricking a hole in the lid material of the capsule and, concurrently, insertion of a coffee liquid outlet tube creating a hole in the bottom disk material of the capsule.

In an embodiment, the capsule may be obtainable by a process as described below.

In an embodiment, the one or more fiber layers may be prepared by means of a wet-laid process, for instance by a conventional paper-making process using a wet-laid machine, in particular by means of an inclined wire papermaking machine or a fourdrinier paper machine, or an air-laid process, for instance by a dry-forming air-laid non-woven manufacturing process, as described in further detail above. Moreover, at least a part of the fibers of the fiber layer(s) may be entangled with each other, in particular by hydroentanglement or needle punching.

In an embodiment, the one or more polymer layers may be applied on a fiber layer for instance as a polymer dispersion, by film extrusion or by lamination. For instance, in case of applying a polymer layer on a fiber layer such that the polymer layer faces towards an exterior or an interior of the capsule, a polymer dispersion may be painted or coated on the fiber layer. For instance, in case of a polymer layer as an intermediate layer between two fiber layers, the polymer layer may be applied by spraying a polymer dispersion in between the two fiber layers while forming the same, for instance by means of a duplex papermaking machine.

In an embodiment, the capsule may be prepared by forming a bottom, a side wall and a lid separately from each other, for instance by (die) cutting or punching (stamping) the individual parts from a sheet of a composite of fiber layer(s) and polymer layer(s), followed by assembling the capsule by combining, such as by (heat-)sealing, the bottom part and the side wall part and subsequently (in particular after having inserted a soluble or brewable food) also the lid part. This approach may in particular be suitable in case of capsule material based on (wet-laid) fiber layers comprising wood pulp.

In another embodiment, the capsule may be prepared by molding a structure comprising a bottom and a side wall by deep-drawing or punch drawing. To this end, the capsule material, in particular the fiber layer(s), advantageously exhibits a high stretchability or tensile strength. Subsequently, in particular after having inserted a soluble or brewable food, the molded structure may be closed by (heat-)sealing with a lid. This approach may in particular be suitable in case of capsule material based on (air-laid) fiber layers comprising fluff pulp.

While the present invention has been described in detail by way of specific embodiments, the invention is not limited thereto and various alterations and modifications are possible, without departing from the scope of the invention.

1. A capsule for preparing a beverage, the capsule comprising:
one or more fiber layers comprising fibers, and
one or more polymer layers comprising a polymer selected from the group consisting of polylactic acid, polybutylene succinate, polybutylene adipate terephthalate, polyhydroxyalkanoate, and a polysaccharide,
wherein the capsule comprises a bottom, a side wall and a lid, wherein the bottom and the side wall are made of the same material and the lid is made of another material,
characterized in that
the bottom and the side wall each comprise one or more fiber layers comprising fluff pulp, and one or more polymer layers comprising a polymer selected from the group consisting of polylactic acid, polybutylene succinate, polybutylene adipate terephthalate, polyhydroxyalkanoate, and a polysaccharide; and
wherein the lid comprises one or more fiber layers comprising wood pulp, and one or more polymer layers comprising a polymer selected from the group consisting of polylactic acid, polybutylene succinate, polybutylene adipate terephthalate, polyhydroxyalkanoate, and a polysaccharide.

2. The capsule according to claim 1, wherein at least one polymer layer is arranged on the one or more fiber layers such that it faces towards an interior of the capsule.

3. The capsule according to claim 1, wherein the capsule comprises two or more fiber layers.

4. The capsule according to claim 3, wherein at least one polymer layer is arranged between two adjacent fiber layers.

5. The capsule according to claim 1, wherein the one or more fiber layers comprises one or more layers comprising wood pulp.

6. The capsule according to claim 1, wherein the one or more fiber layers comprises one or more layers comprising fluff pulp.

7. The capsule according to claim 1, wherein the one or more polymer layers further comprises one or more additives.

8. The capsule according to claim 1, wherein the capsule fulfils at least one of the following properties:
the capsule is biodegradable;
the capsule has a gas transmission rate at 23° C. and a relative humidity of 50% of from 1 to 500 cm³/(m² d bar) as determined in accordance with DIN 53380-3:1998-07;
the capsule has a water vapor transmission rate at 23° C. and a relative humidity of 50% of from 15 to 100 g/(m² d) as determined in accordance with ISO 7783:2018;
the capsule has a water vapor transmission rate at 23° C. and a relative humidity of 85% of from 20 to 250 g/(m² d) as determined in accordance with ISO 7783:2018.

9. The capsule according to claim 1, wherein the capsule fulfils at least one of the following properties:
the capsule complies with the requirements of EN 13432;
the capsule has an oxygen transmission rate at 23° C. and a relative humidity of 50% of from 1 to 500 cm³/(m² d bar) as determined in accordance with DIN 53380-3:1998-07;

10. The capsule according to claim 1, wherein the capsule is a capsule for preparing a coffee or tea.

11. The capsule according to claim 1, wherein at least one polymer layer is arranged on the one or more fiber layers such that it faces towards an exterior of the capsule.

12. The capsule according to claim 2, wherein at least one polymer layer is arranged on the one or more fiber layers such that it faces towards an exterior of the capsule.

13. The capsule according to claim 1, wherein the one or more polymer layers further comprises a plasticizer.
